(19) United States
(12) Patent Application Publication
(10) Pub. No.: US 2004/0065600 A1
(43) Pub. Date: Apr. 8, 2004

(54) Filter for fibrous suspensions

(76) Inventor: Stefano Nicoli, Schio (IT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/467,917

(22) PCT Filed: Feb. 14, 2002
(86) PCT No.: PCT/EP02/01548

(30) Foreign Application Priority Data
Feb. 15, 2001 (IT) V 12001A000039

(51) Int. Cl. B07C 5/12; B07B 13/05

(52) U.S. Cl. 209/672; 209/674

(57) ABSTRACT

A rotary filter (1) for fibrous suspensions (S) is disclosed comprising a rotor (2) coaxially arranged inside a filtering basket (4), an annular hollow space (8) being defined between them. In the annular hollow space (8) there are one or more wing profiles (15) fixed to the outer lateral surface (2a) of the rotor (2) extending in an axial direction along the rotor (2). The outer surface (16) of each wing profile (15) facing the filtering basket has one or more discontinuity zones (16b, 16d) whose points have an increasing distance from the longitudinal axis (3) of the rotor (2).when running on the outer surface (16) of said wing profile (15) in a direction opposite to the rotation direction (V) of the rotor (2).

The present invention relates to a rotary filter for fibrous suspensions, particularly adapted to be used in separation of foreign matter and polluting contraries.

It is well known that in order to separate contraries polluting aqueous suspensions of fibres such as the suspensions used in the paper industry, mechanical devices called strainers are used. Said strainers are generally rotary filters in which the separation of contraries from the suspension occurs through the so called high density screening process.

According to the prior art as for instance disclosed in Italian patent application N. VI98A000008 filed by the present applicant, the rotary filter consists of a central rotor around which a filtering basket is arranged, both being inserted in a holding housing.

The suspension to be purified is conveyed from a feeding zone at the upper part of said housing, through a plurality of diffuser ducts, to the annular hollow space defined between the rotor and the filtering basket.

In this way the fibrous suspension is caused to rotate and is divided into two fractions by the centrifugal force, the first fraction being generally called “accepts” and is the filtered fraction used in the subsequent working stages for making paper.

The second fraction generally called “rejects” consists of the contraries of the fibrous suspension left inside the hollow space and collected in a discharge chamber arranged at the bottom part of the housing to be subsequently ejected.

The contraries left inside the hollow space being arranged during separation on the side wall of the filtering basket, tend to occlude the openings of said wall, causing the phenomenon called “mat formation” in the technical jargon. Such a phenomenon is the reason of the degradation of the filtering power, so that a periodical intervention is required to carry out cleaning or replacement of the filtering basket.

Systems to solve the problem of the “mat formation” are known, using wing profiles arranged inside the hollow space and fixed to the rotor, said profiles on rotation warranting cleaning of the surface of the filtering basket.

According to such a system, the wing profiles inside the hollow space on rotation generate a pulsating vacuum causing detachment of fibres obstructing the basket walls.

Devices applying the above mentioned system are known aiming at carrying out an optimal cleaning of the basket.

Document EP-A-0206975 is for instance known, in which a filter provided with wing profiles is disclosed, whose surface facing the basket has a distance to the basket first increasing and then decreasing so as to generate first a positive pressure and then a negative pressure.

Use of filters with wing profiles of this kind however proved that said filters have the drawback that the generated positive pressure wave enhances basket clogging and causes its jamming when the density rises.

Publication WO 90/07807 is also known, wherein the wing profiles extend in the hollow space in an axial and circumferential direction and have a surface facing the filtering basket with a convex curved shape whose points have a distance relative to the rotation centre of the rotor steadily decreasing when said surface is being run in the direction opposite to the rotation direction of the rotor.

In this way when the rotor is being rotated, the wing profiles rotating jointly therewith, generate a pulsating negative pressure wave in which pressure is being reduced constantly covering the wing surface from the head end to the tail end along the direction opposite to the rotation direction of the rotor.

Such a constantly decreasing development of pressure, shows the limitation not to allow the total detachment of the contraries obstructing the holes made in the wall of the filtering basket and therefore an optimal cleaning of the basket for keeping constant the filtering performance cannot be obtained.

The present invention aims at overcoming said limitation.

More particularly the main object of the invention is to provide a rotary filter improving detachment of the polluting fibres deposited on the inner surface of the filtering basket in comparison with the conventional rotary filters.

Further object of the invention is to provide a rotary filter allowing to handle a greater hourly quantity of fibrous suspension in comparison with the conventional rotary filters.

A last but not least object of the invention is to provide a filter allowing also a greater degree of purification of the fibrous surface in comparison with the known filters.

Said objects are attained by making a filter for fibrous suspensions the main features of which are according to claim 1.

According to a preferred embodiment the filter of the invention has five wing profiles with an axial development for the whole length of the rotor and arranged symmetrically relative to the rotation axis of the rotor according to the vertices of a regular pentagon.

Each profile has the outer surface with curved convex contour facing the filtering basket and defined by three steps connected to each other by discontinuity zones defined by radiused surfaces joining them two by two.

According to further embodiments the wing profiles and the steps made in the curved contour of each wing profile may be made in a different quantity such as five and three profiles respectively.

According to a particular embodiment said radiused surfaces are arranged radially relative to the rotor axis.

The wing profiles are connected to the outer surface of the rotor through joining blocks arranged close to the upper and lower end of the rotor respectively.

Advantageously the rotary filter of the invention allows an increase of the filtering performance, a greater hourly production and less cleaning interventions in comparison with equivalent rotary filters of known type.

The above mentioned objects and advantages will be better understood by reading the following description of a preferred embodiment of the invention which is being given as an illustrative but non limiting example with reference to the accompanying sheets of drawings in which:

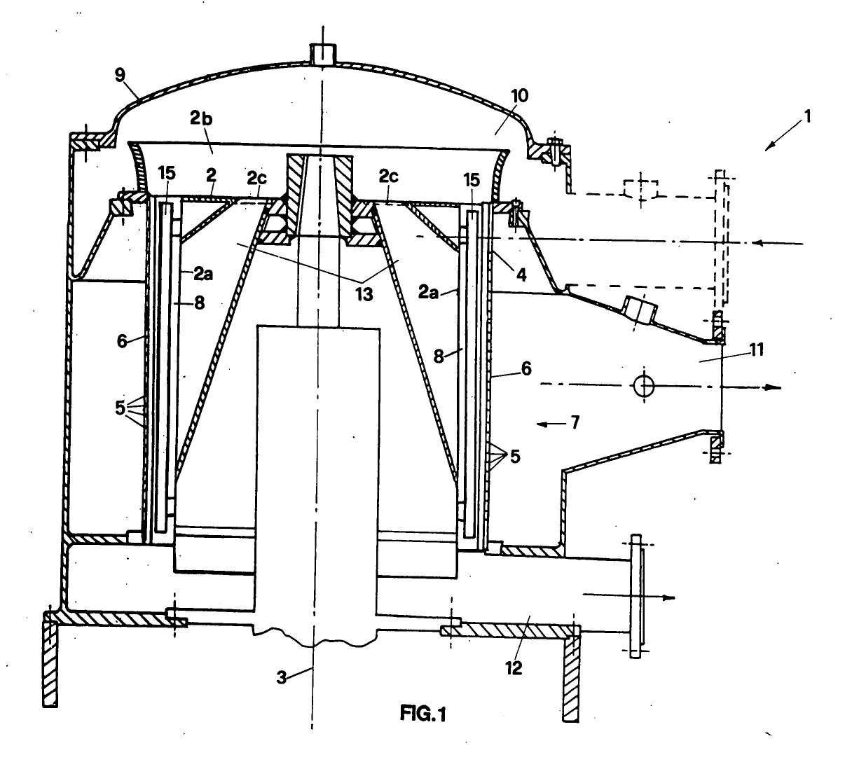

FIG. 1 is a longitudinal sectional view of the rotary filter of the invention;

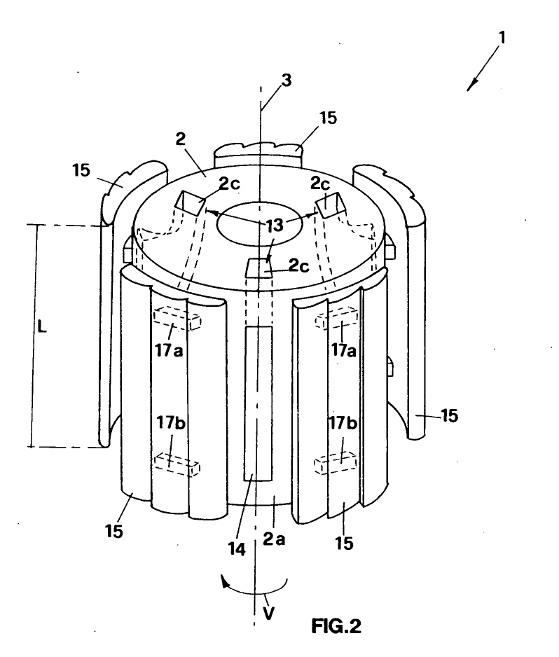

FIG. 2 is an isometric view of the rotor of the filter of the invention;

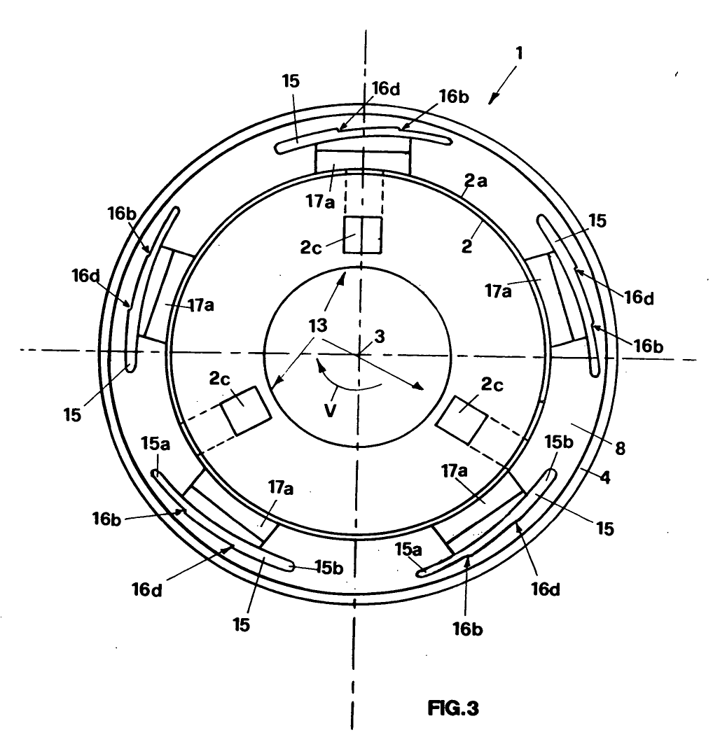

FIG. 3 is a cross sectional view of the filter of the invention;

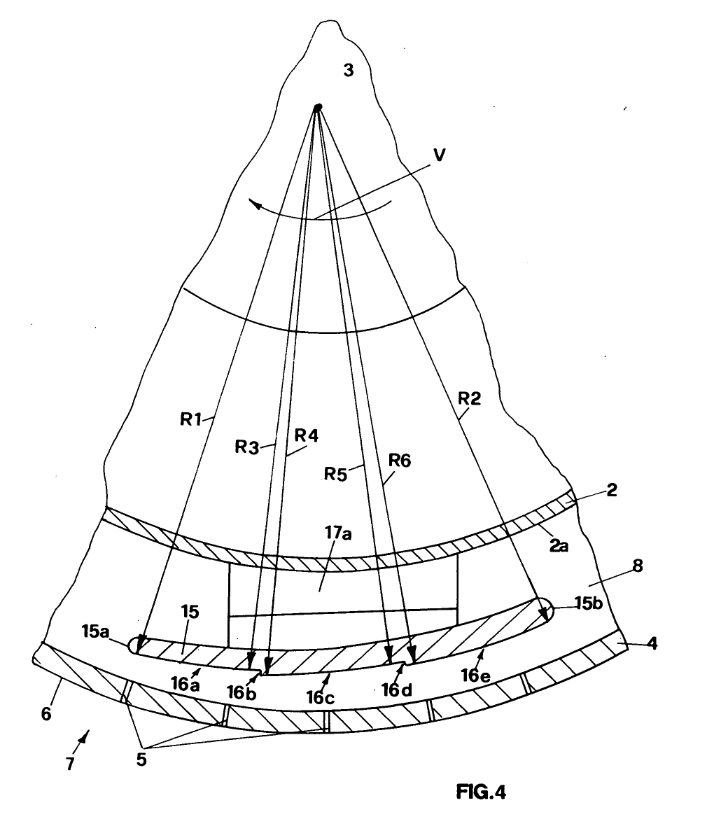

FIG. 4 shows an enlarged detail of the cross sectional view of FIG. 3; and

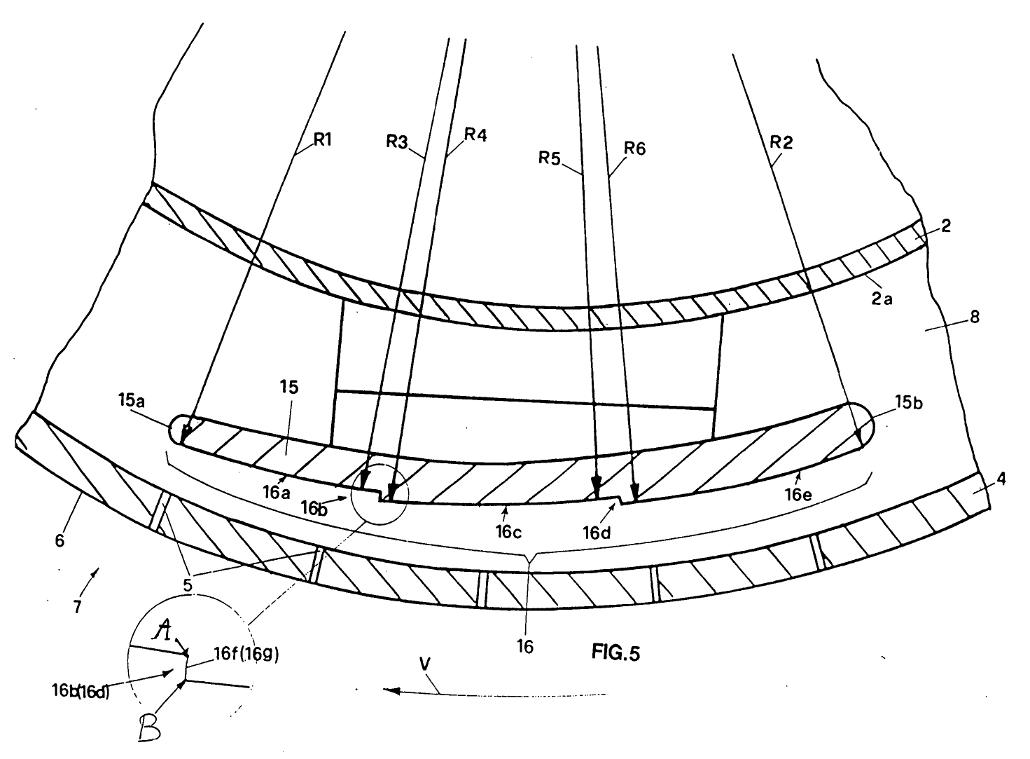

FIG. 5 shows an enlarged detail of FIG. 4.

As shown in FIGS. 1 to 3 the rotary filter of the invention generally indicated with reference numeral 1, comprises a rotor 2 of a generally cylindrical shape arranged with the longitudinal axis 3 in a generally vertical direction and connected to driving means not shown in the drawings, adapted to cause its rotation, and a filtering basket 4 arranged generally coaxially outside the rotor 2, provided with a plurality of openings 5 made in its lateral surface 6 and defining the filtering surface generally indicated with numeral 7.

An outer housing 9 accommodates the filtering basket 4 and the rotor 2, a hollow space 8 being defined between the lateral surface 2a of the rotor 2 and the filtering surface 7 of the filtering basket 5.

Inside the housing 9 one can see:

a feeding chamber 10 for the fibrous suspension S to be filtered, defined at the upper part of the housing 9 and communicating with the upper part 2b of said rotor 2;

a delivery chamber 11 of the filtered product defined at the filtering surface 7 of the filtering basket 5; and

a discharge chamber 12 for the rejected product defined at the lower part of the housing 9.

In the rotor 2 a plurality of ducts generally indicated with numeral 13 are provided, adapted to put the feeding chamber 10 in communication with the annular hollow space 8.

Each of said ducts 13 is developed between an inlet section 2c at the upper base of rotor 2 defining the feeding chamber 9 and an outlet section 14 at the lateral surface 2a of said rotor 2 defining the hollow space 8.

Inside the rotor 2 there are five identical wing profiles 15 symmetrically arranged relative to the rotation axis 3 of rotor 2, said profiles being axially developed for the whole length L of rotor 2.

In the following description making reference to the above mentioned FIGURES of the drawings, only one of the five wing profiles will be described in detail, but what described for a profile clearly applies for any other profile.

As shown in FIGS. 3, 4 and 5, each wing profile 15 has a head end 15a which is arranged at a distance RI relative to the longitudinal axis 3 of rotor 2 which is greater than the distance R2 of the tail end 15b.

According to the invention the outer surface 16 of said wing profile 15 is provided with two discontinuity zones 16b, 16d whose points have an increasing distance from said longitudinal axis 3 running on said outer surface 16 of said wing profile 15 in a direction opposite to the rotation direction of said rotor 2, indicated with arrow V.

Therefore one can see that the convex curved outer surface 16 of the wing profile 15 comprises three steps 16a, 16c, 16e one after the other and mutually connected by said discontinuity zones 16b, 16d, each zone consisting of a generally flat surface 16f, 16g.

More particularly the first step 16a starts at the head end 15a ending at the first discontinuity zone 16b.

The points of the step surface have a distance from the axis 3 of the rotor 2 decreasing from the maximum distance R1 to the minimum distance R3.

With regard to the second step 16c, it starts at the first discontinuity zone 16b ending at the second discontinuity zone 16d and like the first step the points of its surface have a distance relative to the axis 3 of rotor 2 decreasing from the maximum quantity R4 to the minimum quantity R5.

In a similar way the third step 16e starting at the second discontinuity zone 16d ending at the tail end 15b has the distance from the axis 3 of rotor 2 of the points of its surface decreasing from the maximum quantity R6 to the minimum quantity R2.

Therefore one can see that at each discontinuity zone 16b, 16d the points of their corresponding surface 16f, 16g have an increasing distance from the axis 3 of rotor 2 passing from one step to the other in the direction opposite to the rotation direction V of the rotor 2 going from the quantity R3 to the quantity R4 and from the quantity R5 to the quantity R6 respectively.

The discontinuity zones 16b and 16d are axially extending for the whole length of the wing profile so as to have the configuration shown more particularly in FIG. 2.

Each wing profile 15 is connected to the rotor 2 by the interposition of joining blocks 17a, 17b where the fastening means may be screws, welds and the like.

The arrangement of said joining blocks is spacing the wing profile 15 from the rotor 2 and therefore said profile is fully surrounded by the suspension S filled in the hollow space 8.

The outer surface 16 of each wing profile 15 in view of the diminishing curved shape of the profile, generates a set of negative pulsating macropressures (macrowaves) each consisting of a set of pulsating negative micropressures (microwaves), the latter being produced by the particular stepwise configuration of each wing profile with the above described features.

It is the provision of said pulsating negative micropressures not provided in equivalent filters of known type, that combined with the pulsating negative macropressures cause a more efficient detachment from the filtering basket even of the most clinging fibres so as to improve the filtering performance. From the foregoing it is clear that the filter of the invention attains the intended objects.

In the constructional stage further modifications not described and shown in the accompanying drawings may be made to the filter of the invention.

Said constructional versions may for instance consist of a different number of wing profiles, a different arrangement of the profiles along the lateral surface of the rotor or even a different structure and arrangements of the means fastening the wing profiles to the rotor.

It is however to be understood that said not described and illustrated constructional modifications when falling within the scope of the appended claims, should be considered as covered by the present patent.

1) A filter (1) for fibrous suspensions (S) comprising:
a rotor (2) with a generally vertical longitudinal axis (3);
a filtering basket (4) coaxially arranged outside said rotor (2);
an annular hollow space (8) defined between the outer lateral surface (2a) of said rotor (2) and the inner lateral surface of said filtering basket (4);
an outer housing (9) adapted to accommodate said filtering basket (4) and said rotor (2);
a feeding chamber (10) for the fibrous suspension (S) to be filtered, defined at the upper part of said housing (9) and communicating with the upper part (2b) of said rotor (2);
a delivery chamber (11) of the filtered product defined at the outer lateral surface (6) of said filtering basket (4);
a discharge chamber (12) for the rejected product defined at the lower part of said housing (9);
a plurality of ducts (13) formed in said rotor and adapted to put said feeding chamber (10) in communication with said annular hollow space (8);
one or more wing profiles (15) arranged on the outer lateral surface (2a) of said rotor (2) in said annular hollow space (8), developed in an axial direction along said rotor (2), each profile having a curved outer surface (16) with convexity facing said filtering basket (4), said surface running from a head end (15a) to a tail end (15b), wherein said head end (15a) is arranged relative to said longitudinal axis (3) at a distance (R1) greater than the distance (R2) of said tail end (15b), wherein said outer surface (16) of said wing profile (15) presents step surfaces (16a, 16c, 16e) connected one another forming a discontinuity zone (16b, 16d), where the points belonging to each step surface (16a, 16c) have a distance (R1, R4) from the vertical longitudinal axis (3) minor than the distance (R4, R6) of the points belonging to the next step surface (16c, 16e) reached by running in the direction opposite to the rotation direction (V) of said rotor (2).

2) The filter (1) according to the claim 1, wherein each discontinuity zone (16b, 16d) is developed along the longitudinal direction of said rotor (2) and defines on said outer surface (16) a couple of steps (16a, 16c; 16c, 16e) whose surfaces are radiused by said discontinuity zone (16b, 16d).

3) The filter (1) according to claim 1, wherein each discontinuity zone (16b, 16d) is defined by a flat surface.

4) The filter (1) according to claim 3, wherein said flat surface is radial.

5) The filter (1) according to claim 1, wherein each discontinuity zone (16b, 16d) is defined by a curved surface.

6) The filter (1) according to claim 1, wherein the distance between said head end (15a) and said tail end (15b) is comprised between 100 mm and 600 mm.

7) The filter (1) according to claim 1, wherein each wing profile (15) is axially extended for the whole length (L) of said rotor (2).

8) The filter (1) according to claim 1, wherein each wing profile (15) is connected to said rotor (2) by fastening means and interposition of joining blocks (17a, 17b) adapted to space the profile from said rotor (2).
